(19) United States
(12) Patent Application Publication
(10) Pub. No.: US 2022/0398868 A1
(43) Pub. Date: Dec. 15, 2022

(54) ACTION RECOGNITION LEARNING DEVICE, ACTION RECOGNITION LEARNING METHOD, ACTION RECOGNITION LEARNING DEVICE, AND PROGRAM

(71) Applicant: NIPPON TELEGRAPH AND TELEPHONE CORPORATION, Tokyo (JP)

(72) Inventors: Takashi HOSONO, Tokyo (JP); Yongqing SUN, Tokyo (JP); Kazuya HAYASE, Tokyo (JP); Jun SHIMAMURA, Tokyo (JP); Kiyohito SAWADA, Tokyo (JP)

(73) Assignee: NIPPON TELEGRAPH AND TELEPHONE CORPORATION, Tokyo (JP)

(21) Appl. No.: 17/774,113

(22) PCT Filed: Oct. 30, 2020
(86) PCT No.: PCT/JP2020/040903

§ 371 Date: May 3, 2022

(30) Foreign Application Priority Data
Nov. 5, 2019 (JP) 2019-200642

(51) Int. Cl. G06V 40/20; G06V 10/774; G06V 10/24; G06V 10/77

(52) U.S. Cl. CPC G06V 40/20; G06V 10/7747; G06V 10/245; G06V 10/7715; G06V 2201/08

(57) ABSTRACT

The present invention makes it possible to cause an action recognizer capable of recognizing actions with high accuracy and with a small quantity of learning data to learn. An input unit 101 receives input of a learning video and an action label indicating an action of an object, a detection unit 102 detects a plurality of objects included in each frame image included in the learning video, a direction calculation unit 103 calculates a direction of a reference object, which is an object to be used as a reference among the plurality of detected objects, a normalization unit 104 normalizes the learning video so that a positional relationship between the reference object and another object becomes a predetermined relationship, and an optimization unit 106 optimizes parameters of an action recognizer to estimate the action of the object in the inputted video based on the action estimated by inputting the normalized learning video to the action recognizer and the action indicated by the action label.

### TECHNICAL FIELD

The present disclosure relates to an action recognition learning device, an action recognition learning method, an action recognition device and a program.

### BACKGROUND ART

Conventionally, research has been underway on action recognition technologies that mechanically recognize what kind of action an object in an inputted video (e.g., person or vehicle) is performing. The action recognition technologies have a wide range of industrial applications such as analyses of monitoring cameras and sports videos or understanding by robots about human action. Particularly, recognizing “a person loads a vehicle” or “a robot holds a tool,” that is, actions generated by interaction among a plurality of objects constitutes an important function for a machine to deeply understand events in a video.

As shown in FIG. 1, a publicly known action recognition technology realizes action recognition on an inputted video by outputting an action label indicating what kind of action is performed using a pre-learned action recognizer. For example, Non-Patent Literature 1 realizes high recognition accuracy by utilizing deep learning such as convolutional neural network (CNN). More specifically, according to Non-Patent Literature 1, a frame image group and an optical flow group, which are motion features corresponding to the frame image group are extracted from an input video. The action recognition technology performs learning of the action recognizer and action recognition using 3D CNN that convolves a spatiotemporal filter on the extracted frame image group and optical flow group.

### CITATION LIST

### Non-Patent Literature

Non-Patent Literature 1: J. Carreira and A. Zisserman, “Quo vadis, action recognition? a new model and the kinetics dataset”, in Proc. on Int. Conf. on Computer Vision and Pattern Recognition, 2018.

### SUMMARY OF THE INVENTION

### Technical Problem

However, there has been a problem that a large quantity of learning data is required for the technology using CNN such as the one described in Non-Patent Literature 1 to exhibit high performance. One of such factors is diversity of relative positions of a plurality of objects in the case of actions by interaction among the objects. For example, as shown in FIG. 2, even if the action is limited to an action “a person loads a vehicle,” there can be innumerable visible patterns such as a case where a person loads a vehicle located above in the video from below (left figure in FIG. 2), a case where a person loads a vehicle located left in the video from right (middle figure in FIG. 2), a case where a person loads a vehicle located right from left (right figure in FIG. 2) due to diversity of relative positions of objects (person and vehicle). The publicly known technologies require a large quantity of learning data to construct a recognizer robust to such various visible patterns.

On the other hand, it is necessary to add a type of an action, a time of occurrence and a position to a video in order to construct learning data of the action recognizer. There has been a problem that human costs for constructing such learning data is high and it is not easy to prepare sufficient learning data. When a small quantity of learning data is used, there has been a problem that a probability that the action to be recognized will not be included in a data set increases, resulting in a problem that recognition accuracy deteriorates.

The technology of the present disclosure has been implemented in view of the above problems, and it is an object of the present disclosure to provide an action recognition learning device, an action recognition learning method and a program that can cause an action recognizer capable of performing action recognition with high accuracy and with a small quantity of learning data to learn.

It is another object of the technology of the present disclosure to provide an action recognition device and a program capable of recognizing actions with high accuracy with a small quantity of learning data.

### Means for Solving the Problem

A first aspect of the present disclosure is an action recognition learning device including an input unit, a detection unit, a direction calculation unit, a normalization unit and an optimization unit, in which the input unit receives input of a learning video and an action label indicating an action of an object, the detection unit detects a plurality of objects included in each frame image included in the learning video, the direction calculation unit calculates a direction of a reference object, which is an object to be used as a reference among the plurality of objects detected by the detection unit, the normalization unit normalizes the learning video so that a positional relationship between the reference object and another object becomes a predetermined relationship, and the optimization unit optimizes parameters of an action recognizer to estimate an action of an object in the inputted video based on the action estimated by inputting the learning video normalized by the normalization unit to the action recognizer and the action indicated by the action label.

A second aspect of the present disclosure is an action recognition device including an input unit, a detection unit, a direction calculation unit, a normalization unit and a recognition unit, in which the input unit receives input of an input video, the detection unit detects a plurality of objects included in each frame image included in the input video, the direction calculation unit calculates a direction of a reference object, which is an object to be used as a reference among the plurality of objects detected by the detection unit, the normalization unit normalizes the input video so that a positional relationship between the reference object and another object becomes a predetermined relationship, and the recognition unit estimates the action of the object in the inputted video using an action recognizer caused to have learned by the action recognition learning device.

A third aspect of the present disclosure is an action recognition learning method including receiving by an input unit, input of a learning video and an action label indicating an action of an object, detecting by a detection unit, a plurality of objects included in each frame image included in the learning video, calculating by a direction calculation unit, a direction of a reference object, which is an object to be used as a reference among the plurality of objects detected by the detection unit, normalizing by a normalization unit, the learning video so that a positional relationship between the reference object and another object becomes a predetermined relationship, and optimizing by an optimization unit, parameters of an action recognizer to estimate the action of the object in the inputted video based on the action estimated by inputting the learning video normalized by the normalization unit to the action recognizer and the action indicated by the action label.

A fourth aspect of the present disclosure is a program for causing a computer to function as each unit constituting the action recognition learning device.

### Effects of the Invention

According to the technology of the present disclosure, it is possible to cause an action recognizer that can recognize an action with high accuracy and with a small quantity of learning data to learn. According to the technology of the present disclosure, it is possible to perform action recognition with high accuracy.

### BRIEF DESCRIPTION OF DRAWINGS

FIG. 1 is a diagram illustrating an example of a publicly known action recognition technology.

FIG. 2 is a diagram illustrating an example of diversity of relative positions of objects in the case of actions by interaction among a plurality of objects.

FIG. 3 is a diagram illustrating an overview of an action recognition device of the present disclosure.

FIG. 4 is a block diagram illustrating a schematic configuration of a computer that functions as an action recognition device of the present disclosure.

FIG. 5 is a block diagram illustrating an example of a functional configuration of the action recognition device of the present disclosure.

FIG. 6 is a diagram illustrating an overview of a process of calculating a direction of a reference object.

FIG. 7 is a diagram illustrating an overview of a normalization process of the present disclosure.

FIG. 8 is a diagram illustrating an example of videos before and after normalization.

FIG. 9 is a diagram illustrating an overview of a learning/estimation method according to an experiment example.

FIG. 10 is a flowchart illustrating a learning processing routine of the action recognition device of the present disclosure.

FIG. 11 is a flowchart illustrating an action recognition processing routine of the action recognition device of the present disclosure.

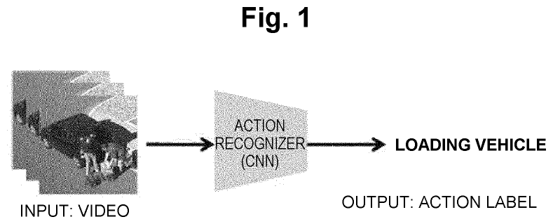

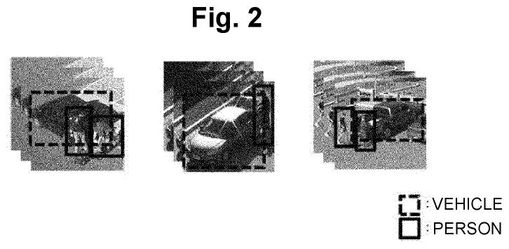

### DESCRIPTION OF EMBODIMENTS

<Overview of Embodiments of Present Disclosure>

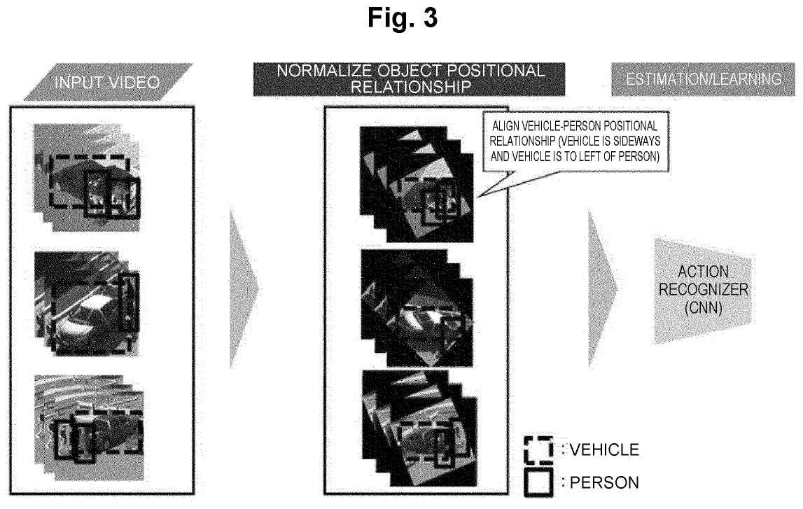

First, an overview of embodiments of the present disclosure will be described. According to a technology of the present disclosure, an input video is normalized so that relative positions of a plurality of objects have a certain one positional relationship to suppress influences of diversity of visible patterns (FIG. 3). More specifically, an angle of a reference object, which is an object to be used as a reference in a predetermined video is estimated so that a direction of the reference object becomes a predetermined direction and the video is rotated so that the angle becomes constant (e.g., 90 degrees). Next, the video is flipped left and right if necessary so that the left-right positional relationship of the object becomes constant (e.g., the vehicle is on the left and the person is on the right). By performing such a normalization process, the positional relationships among a plurality of objects that vary depending on videos are expected to be approximately constant among the normalized videos. The videos thus normalized are used as input during learning and during action recognition. The technology of the present disclosure in such a configuration can cause an action recognizer capable of performing action recognition with high accuracy and with a small quantity of learning data to learn.

<Configuration of Action Recognition Device according to Embodiment of Technology of Present Disclosure>

Hereinafter, examples of embodiment of the technology of the present disclosure will be described with reference to the accompanying drawings. Note that identical or equivalent components or parts among the drawings are assigned identical reference numerals. Dimension ratios among the drawings may be exaggerated for convenience of description and may be different from the actual ratios.

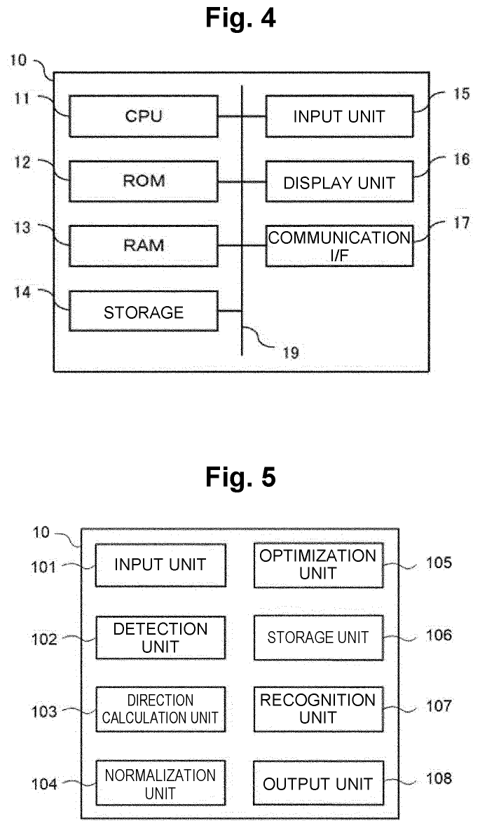

FIG. 4 is a block diagram illustrating a hardware configuration of an action recognition device 10 according to the present embodiment. As shown in FIG. 4, the action recognition device 10 includes a CPU (central processing unit) 11, a ROM (read only memory) 12, a RAM (random access memory) 13, a storage 14, an input unit 15, a display unit 16 and a communication interface (I/F) 17. The respective components are connected so as to be communicable with each other via a bus 19.

The CPU 11 is a central processing unit and executes various programs or controls the respective components. That is, the CPU 11 reads a program from the ROM 12 or the storage 14 and executes the program using the RAM 13 as a work region. The CPU 11 controls the respective components and performs various operation processes according to the program stored in the ROM 12 or the storage 14. According to the present embodiment, the ROM 12 or the storage 14 stores programs to execute a learning process and an action recognition process.

The ROM 12 stores various programs and various data. The RAM 13 temporarily stores programs or data as the work region. The storage 14 is constructed of a storage device such as an HDD (hard disk drive) or an SSD (solid state drive) and stores various programs including an operating system and various data.

The input unit 15 includes a pointing device such as a mouse and a keyboard, and is used to make various inputs.

The display unit 16 is, for example, a liquid crystal display and displays various information. By adopting a touch panel scheme, the display unit 16 may be configured to also function as the input unit 15.

The communication interface 17 is an interface to communicate with other devices, and standards such as Ethernet (registered trademark), FDDI and Wi-Fi (registered trademark) are used.

Next, a functional configuration of the action recognition device 10 will be described. FIG. 5 is a block diagram illustrating an example of the functional configuration of the action recognition device 10. As shown in FIG. 5, the action recognition device 10 includes an input unit 101, a detection unit 102, a direction calculation unit 103, a normalization unit 104, an optimization unit 105, a storage unit 106, a recognition unit 107 and an output unit 108 as the functional configuration. Each functional component is implemented by the CPU 11 reading a program stored in the ROM 12 or the storage 14, deploying the program to the RAM 13 and executing the program. Hereinafter, the functional configuration during learning and the functional configuration during action recognition will be described separately.

<<Functional Configuration during Learning>>

The functional configuration during learning will be described. The input unit 101 receives input of a set of a learning video, an action label indicating an action of an object and an optical flow indicating an action feature corresponding to each frame image included in the learning video as learning data. The input unit 101 passes the learning video to the detection unit 102. The input unit 101 passes the action label and the optical flow to the optimization unit 105.

The detection unit 102 detects a plurality of objects included in each frame image included in the learning video. A case will be described in the present embodiment where objects detected by the detection unit 102 are a person and a vehicle. More specifically, the detection unit 102 detects a region and a position of an object included in a frame image. Next, the detection unit 102 detects a type of the detected object indicating whether it is a person or a vehicle. A useful method can be used for the object detection method. The method can be implemented, for example, by applying an object detection technique described in Reference 1 below to each frame image. By using an object tracking technique described in Reference 2 for an object detection result with respect to one frame, the method may be configured to estimate types and positions of objects in second and subsequent frames.
[Reference 1] K. He, G. Gkioxari, P. Dollar and R. Girshick, “Mask R-CNN”, in Proc. IEEE Int Conf. on Computer Vision, 2017.
[Reference 2] A. Bewley, Z. Ge, L. Ott, F. Ramos, B. Uperoft, “Simple online and realtime tracking”, in Proc. IEEE Int. Conf. on Image Processing, 2017.

The detection unit 102 passes the learning video and the positions and types of the plurality of detected objects to the direction calculation unit 103.

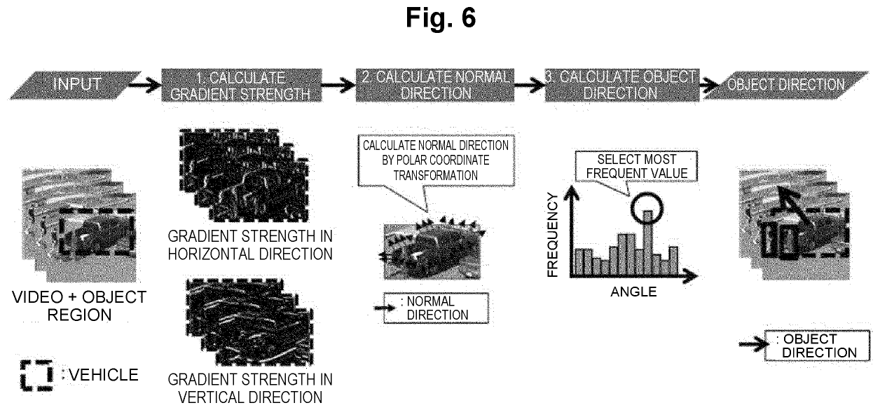

The direction calculation unit 103 calculates a direction of a reference object, which is an object to be used as a reference among the plurality of objects detected by the detection unit 102. FIG. 6 illustrates an overview of a process of calculating a direction of a reference object by the direction calculation unit 103. First, the direction calculation unit 103 calculates gradient strength of a contour of the reference object about a region R of the reference object included in each frame image. In the present disclosure, the reference object is set based on the type of an object. For example, among the plurality of detected objects, an object, the type of which is “vehicle” is used as a reference object.

Next, the direction calculation unit 103 calculates a normal vector with a contour of the reference object based on the gradient strength of the region R of the reference object. A useful method can be used to calculate the normal vector of the contour of the reference object. When using, for example, a Sobel filter, it is possible to obtain an edge component v_{i,x} in a longitudinal direction and an edge component h_{i,x} in a horizontal direction for a certain position xeR in an image of an i-th frame from a response of the Sobel filter. By transforming these values into polar coordinates, it is possible to calculate a normal direction. At this time, since the sign of each edge component depends on a lightness/darkness difference between an object and a background, positive/negative signs may be inverted depending on the video and the object direction may differ from one video to another. Therefore, as shown in equations (1) and (2) below, when the edge component v_{i,x} in the longitudinal direction has a negative value, polar coordinate transformation is applied after inverting both the positive and negative signs of v_{i,x} and h_{i,x}, a normal direction θ_{i,x} is calculated in each pixel as shown in equation (3) below.

$$\begin{matrix}[ Math . 1 ] & \\ \text{?} = \{ \begin{matrix}\text{?} & if 0 \leq \text{?} \\ \text{?} & if \text{?} < 0\end{matrix} & ( 1 )\end{matrix}$$

$$\begin{matrix}[ Math . 2 ] & \\ \text{?} = \{ \begin{matrix}\text{?} & if 0 \leq \text{?} \\ \text{?} & if \text{?} < 0\end{matrix} & ( 2 )\end{matrix}$$

$$\begin{matrix}[ Math . 3 ] & \\ \text{?} = arccos \text{?} & ( 3 )\end{matrix}$$

$$\text{?} \text{indicates text missing or illegible when filed}$$

Next, the direction calculation unit 103 estimates a direction θ of the reference object based on the angle of the normal of the contour of the reference object. If the shapes of the objects are similar, a most frequent value of the object contour in the normal direction is the same between the objects. In the case of, for example, a vehicle, the vehicle generally has a rectangular parallelepiped shape, and so the floor-roof direction has the most frequent value. Based on such a concept, the direction calculation unit 103 calculates the most frequent value of the object contour in the normal direction as the direction θ of the reference object. The direction calculation unit 103 passes the learning video, the positions and types of the plurality of detected objects and the calculated direction θ of the reference object to the normalization unit 104.

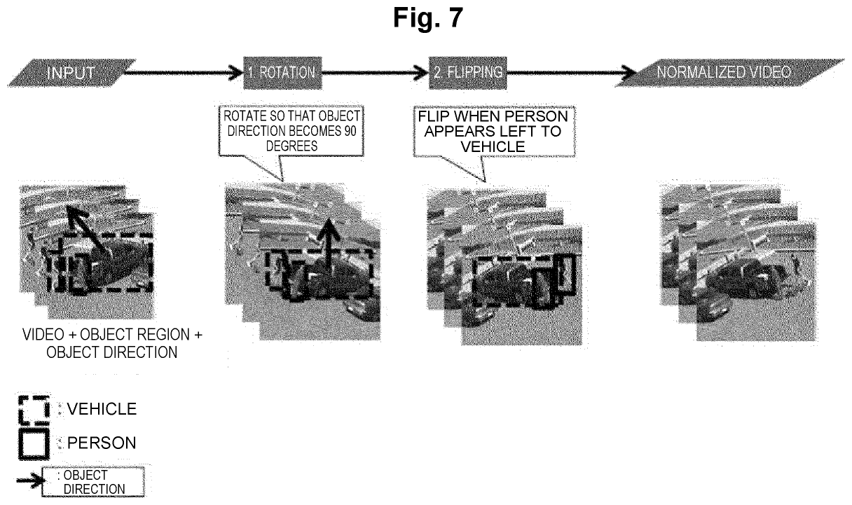

The normalization unit 104 normalizes the learning video so that a positional relationship between the reference object and another object becomes a predetermined relationship. More specifically, as shown in FIG. 7, the normalization unit 104 rotates the learning video so that the direction θ of the reference object becomes the predetermined direction and performs normalization by flipping the rotated learning video so that the positional relationship between the reference object and the other object becomes the predetermined relationship.

More specifically, the normalization unit 104 rotates and flips the learning video based on the detected object and the direction θ of the reference object so that the positional relationship between the detected person and vehicle becomes constant. The present disclosure assumes the predetermined relationship to be such a relationship that when the direction of the vehicle, which is the reference object, is upward (90 degrees), the person is located on the right of the vehicle. Hereinafter, a case will be described where the normalization unit 104 normalizes the learning video so that the predetermined relationship is obtained.

First, the normalization unit 104 rotates each frame image in the video and the optical flow by 0-90 degrees clockwise using the direction θ of the reference object calculated by the direction calculation unit 103. Next, when the left-right positional relationship between the person and the vehicle is not set to a predetermined relationship, the normalization unit 104 flips each rotated frame image using the detection result of the object. More specifically, in an initial frame image of the video, when the center coordinates of the human region are located on the left side of the center coordinates of the vehicle region, the predetermined relationship is not set. Thus, the normalization unit 104 flips each frame image left and right. That is, by flipping each frame image left and right, the normalization unit 104 performs transformation so that the person is located on the right side of the vehicle.

Here, when there are a plurality of people or vehicles in the video, the positional relationship may not be uniquely determined. For example, it is when people and vehicles are lined up in order of person—vehicle—person in the video. In the case of an object that appears in the video, but performs no action, such an object is assumed to move less than an object in action or an object that is the target of the action. For example, motion of a person who does not load the vehicle is considered to move less than a person who loads the vehicle. Thus, utilizing the optical flow makes it possible to narrow down target objects. More specifically, the normalization unit 104 calculates the sum of L2-norms of a moving vector of the optical flow about each region of the plurality of objects in the video. The normalization unit 104 determines the positional relationship between object types using only a region where the calculated sum of norms becomes a maximum for each object type.

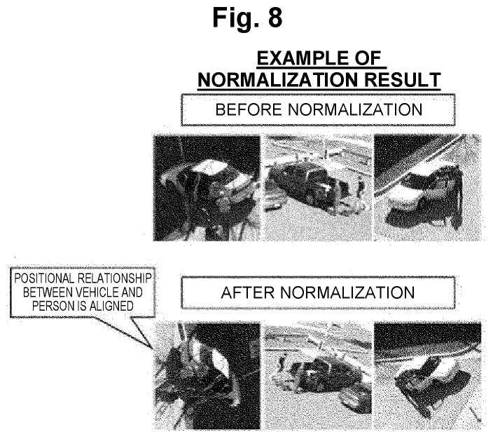

FIG. 8 illustrates an example of the video before normalization (upper figures in FIG. 8) and an example of the video after normalization (lower figures in FIG. 8). As shown in FIG. 8, when normalization is performed, the positional relationship between the person and the vehicle is aligned. The normalization unit 104 passes the normalized learning video to the optimization unit 105.

The optimization unit 105 optimizes parameters of an action recognizer to estimate an action of an object in the inputted video based on the action estimated by inputting the learning video normalized by the normalization unit 104 to the action recognizer and the action indicated by the action label. More specifically, the action recognizer is a model that estimates an action of an object in the inputted video, and, for example, CNN can be adopted therefor.

The optimization unit 105 acquires parameters of the current action recognizer from the storage unit 106 first. Next, the optimization unit 105 inputs the normalized learning video and the optical flow to the action recognizer, and thereby estimates the action of the object in the learning video. The optimization unit 105 optimizes the parameters of the action recognizer based on the estimated action and the inputted action label. As an optimization algorithm, a useful algorithm such as the method described in Non-Patent Literature 1 can be adopted. The optimization unit 105 stores the parameters of the optimized action recognizer in the storage unit 106.

The parameters of the action recognizer optimized by the optimization unit 105 are stored in the storage unit 106.

During learning, the parameters of the action recognizer are optimized by repeating the respective processes by the input unit 101, the detection unit 102, the direction calculation unit 103, the normalization unit 104 and the optimization unit 105 until a predetermined end condition is satisfied. Even if the learning data inputted to the input unit 101 is a small amount, such a configuration makes it possible to cause the action recognizer that can perform action recognition with high accuracy to learn.

<<Functional Configuration during Action Recognition>>

A functional configuration during action recognition will be described. The input unit 101 receives input of the input video and the optical flow of the input video. The input unit 101 passes the input video and the optical flow to the detection unit 102. Note that during action recognition, processes by the detection unit 102, the direction calculation unit 103 and the normalization unit 104 are similar to the processes during learning. The normalization unit 104 passes the normalized input video and the optical flow to the recognition unit 107.

The recognition unit 107 estimates the action of the object in the inputted video using the learned action recognizer. More specifically, the recognition unit 107 acquires the parameters of the action recognizer optimized by the optimization unit 105 first. Next, the recognition unit 107 inputs the input video normalized by the normalization unit 104 and the optical flow to the action recognizer, and thereby estimates the action of the object in the input video. The recognition unit 107 passes the action of the estimated object to the output unit 108.

The output unit 108 outputs the action of the object estimated by the recognition unit 107.

<Experiment Example using Action Recognition Device according to Embodiment of Present Disclosure>

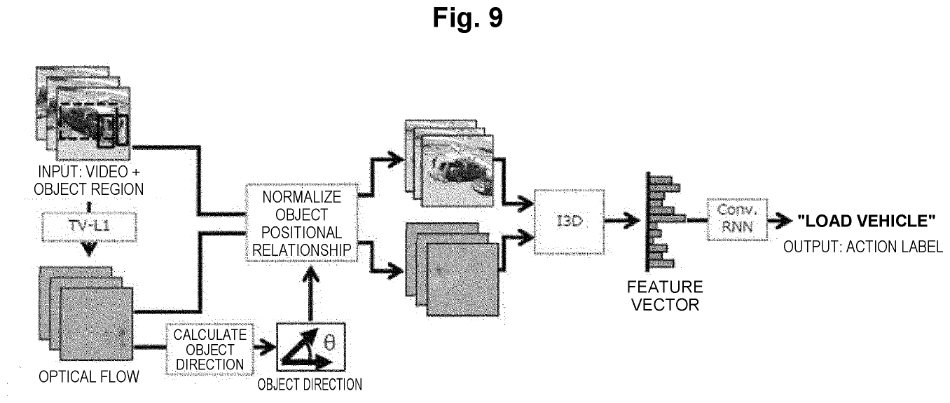

Next, an experiment example using the action recognition device 10 according to the embodiment of the present disclosure will be described. FIG. 9 illustrates an overview of the learning/estimation method in the present experiment example. In the present experiment example, action recognition was performed by inputting an output of a fifth layer, when the video and the optical flow were inputted to Inflated 3D ConvNets (I3D) (Non-Patent Literature 1) to a convolutional recurrent neural network (Conv. RNN) and classifying the action type. At this time, TV-L1 algorithm (Reference 3) was used to calculate the optical flow. For the I3D network parameter, a parameter learned by published Kinetics Dataset (Reference 4) was used. Learning of the action recognizer was conducted only on Conv. RNN, and for a Conv. RNN network model, the one published in Reference 5 was used. The object regions were given manually and it was assumed that the object regions were estimated by object detection or the like.
[Reference 3] C. Zach, T. Pock, H. Bischof, “A Duality Based Approach for Realtime TV-L1 Optical Flow,” Pattern Recognition, vol. 4713, 2017, pp.214-223.
[Reference 4] W. Kay, J. Carreira, K. Simonyan, B. Zhang, C. Hillier, S. Vijayanarasimhan, F. Viola, T. Green, T. Back, P. Natsev, M. Suleyman, A. Zisserman, “The Kinetics Human Action Video Dataset,” arXiv preprint, arXiv: 1705.06950, 2017.
[Reference 5] Internet
<URL:https://github.com/marshimarocj/conv_rnn_trn>

For data to be evaluated, an ActEV data set (Reference 6) was used. The data set includes a total of 2466 videos that captured 18 action types, 1338 of which were used for learning and the rest were used for accuracy evaluation. The learning data is small compared to general action recognition, which is suitable for verifying that the technology of the present disclosure is effective when the learning data is small. For example, according to Reference 4, since there are 400 or more pieces of learning data per type of action, it is obvious that the learning data in the present experiment example is small in comparison with the fact that 7200 pieces of learning data are necessary for 18 types of action. The data set includes 8 types of action by person-vehicle interaction and other 10 types of action. In the present experiment example, object position normalization was applied to only 8 types of action in the former, and the input video and the optical flow were directly inputted to the action recognition unit for the other actions. For evaluation indices, a matching rate (rate of correct answers) by action type and an average matching rate obtained by averaging matching rates by action type were used. Effectiveness of the process was evaluated using the technology of the present disclosure except the normalization unit 104.
[Reference 6] G. Awad, A. Butt, K. Curtis, Y. Lee, J. Fiscus, A. Godil, D. Joy, A. Delgado, A. F. Smeaton, Y. Graham, W. Kraaij, G. Quenot, J. Magalhaes, D. Semedo, S. Blasi, “TRECVID 2018: Benchmarking Video Activity Detection, Video Captioning and Matching, Video Storytelling Linking and Video Search,” TRECVID2018, 2018.

<<Evaluation Results>>

The evaluation results are shown in Table 1 below. Note that in Table 1, bold numbers are maximum values in the respective rows.

TABLE 1

| Person/ | | Not | |
|---|---|---|---|
| vehicle action? | Action type | normalized | Normalized |
| ✓ | Loading | 0.437 | 0.540 |
| ✓ | Unloading | 0.251 | 0.174 |
| ✓ | Open trunk | 0.243 | 0.129 |
| ✓ | Closing trunk | 0.116 | 0.096 |
| ✓ | Opening | 0.307 | 0.308 |
| ✓ | Closing | 0.362 | 0.405 |
| ✓ | Exiting | 0.384 | 0.495 |
| ✓ | Entering | 0.358 | 0.416 |
| | Vehicle u-turn | 0.458 | 0.630 |
| | Vehicle turning right | 0.682 | 0.733 |
| | Vehicle turning left | 0.609 | 0.682 |
| | Pull | 0.707 | 0.785 |
| | Activity carrying | 0.950 | 0.950 |
| | Transport heavy carry | 0.672 | 0.597 |
| | Talking | 0.774 | 0.786 |
| | Specialized talking phone | 0.043 | 0.041 |
| | Specialized texting phone | 0.003 | 0.003 |
| | Riding | 0.933 | 0.907 |
| | Average matching rate | 0.307 | 0.321 |
| | (person/vehicle action | | |
| | only) | | |
| | Average matching rate | 0.461 | 0.482 |
| | (total) | | |

From Table 1, it is seen that adding the normalization process of the present disclosure has improved the matching rate in many actions. It is also seen that the average matching rate has improved by approximately 0.02. When the actions are narrowed down to only actions by normalized person-vehicle interaction, the average matching rate (person-vehicle actions only) (second row from the bottom of Table 1) has also improved. From the above, it was confirmed that the accuracy of action recognition was improved by the action recognition device 10 of the present disclosure and the technology of the present disclosure. It was also confirmed that the action recognition device 10 of the present disclosure can cause the action recognizer capable of performing action recognition with high accuracy and with a small quantity of learning data to learn.

<Operations of Action Recognition Device according to Embodiment of Technology of Present Disclosure>

Next, operation of the action recognition device 10 will be described.

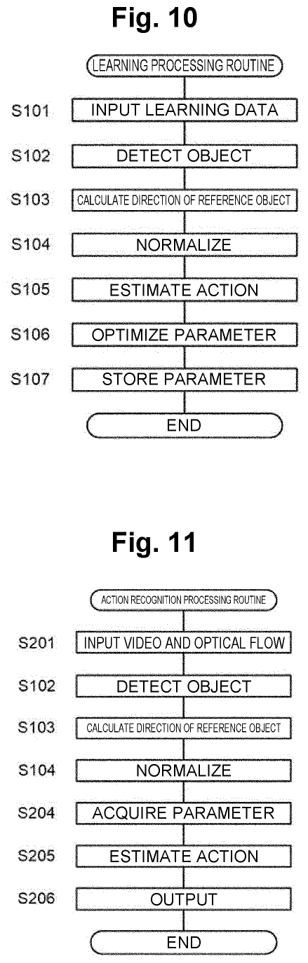

FIG. 10 is a flowchart illustrating a flow of a learning processing routine by the action recognition device 10. The learning processing routine is executed by the CPU 11 reading a program from the ROM 12 or the storage 14, deploying the program to the RAM 13 and executing the program.

In step S101, the CPU 11, as the input unit 101, receives input of a set of a learning video, an action label indicating an action of an object and an optical flow indicating motion features corresponding to each frame image included in the learning video as learning data.

In step S102, the CPU 11, as the detection unit 102, detects a plurality of objects included in each frame image included in the learning video.

In step S103, the CPU 11, as the direction calculation unit 103, calculates a direction of a reference object, which is an object to be used as a reference among the plurality of objects detected in step S102.

In step S104, the CPU 11, as the normalization unit 104, normalizes the learning video so that a positional relationship between the reference object and another object becomes a predetermined relationship.

In step S105, the CPU 11, as the optimization unit 105, inputs the learning video normalized in step S104 to the action recognizer to estimate the action of the object in the inputted video and estimates the action.

In step S106, the CPU 11, as the optimization unit 105, optimizes parameters of the action recognizer based on the action estimated in step S105 and the action indicated by the action label.

In step S107, the CPU 11, as the optimization unit 105, stores the optimized parameters of the action recognizer in the storage unit 106 and ends the process. Note that during learning, the action recognition device 10 repeats step S101 to step S107 until end conditions are satisfied.

FIG. 11 is a flowchart illustrating a flow of an action recognition processing routine by the action recognition device 10. The action recognition processing routine is executed by the CPU 11 reading a program from the ROM 12 or the storage 14, deploying the program to the RAM 13 and executing the program. Note that processes similar to the processes of the learning processing routine are assigned the same reference numerals and description thereof is omitted.

In step S201, the CPU 11, as the input unit 101, receives input of an input video and an optical flow of the input video.

In step S204, the CPU 11, as the recognition unit 107, acquires the parameters of the action recognizer optimized by the learning process.

In step S205, the CPU 11, as the recognition unit 107, inputs the input video normalized in step S104 and the optical flow to the action recognizer and thereby estimates the action of the object in the input video.

In step S206, the CPU 11, as the output unit 108, outputs the action of the object estimated in step S205 and ends the process.

As described above, the action recognition device according to the embodiment of the present disclosure receives input of a learning video, an action label indicating an action of an object and detects a plurality of objects included in each frame image included in the learning video. Furthermore, the action recognition device calculates a direction of a reference object, which is an object to be used as a reference among a plurality of detected objects and normalizes the learning video so that a positional relationship between the reference object and another object becomes a predetermined relationship. Furthermore, the action recognition device can cause an action recognizer capable of performing action recognition with high accuracy and with a small quantity of learning data to learn, to optimize parameters of the action recognizer based on the action estimated by inputting the normalized learning video to the action recognizer to estimate an action of an object in the inputted video and an action indicated by an action label.

The action recognition device according to the embodiment of the present disclosure receives input of an input video and detects a plurality of objects included in each frame image included in the input video.

Furthermore, the action recognition device calculates a direction of a reference object, which is an object to be used as a reference among the plurality of detected objects and normalizes the input video so that a positional relationship between the reference object and another object becomes a predetermined relationship. Furthermore, the action recognition device estimates an action of an object in an inputted video using an action recognizer caused to have learned by the technology of the present disclosure, and can thereby perform action recognition with high accuracy.

Normalization makes it possible to suppress influences of diversity of visible patterns on learning and action recognition. Utilizing the optical flow makes it possible to narrow down target objects appropriately even when there are a plurality of objects about a certain object type in the video. Thus, even when there are a plurality of objects in the video, it is possible to use the objects as learning data and cause the action recognizer capable of performing action recognition with high accuracy and with a small quantity of learning data to learn.

Note that the present disclosure is not limited to the aforementioned embodiments, but various modifications and applications can be made without departing from the spirit and scope of the present invention.

For example, although the above embodiments have been described on the assumption that the optical flow is inputted to the action recognizer, the action recognition device may also be configured without any optical flow. In this case, the normalization unit 104 may be configured to simply assume an average value or a maximum value of a plurality of object positions as the position of a person or a vehicle and then determine the positional relationship.

Although it has been assumed in the above embodiments that the action recognition device 10 performs learning of the action recognizer and action recognition, the present invention need not be limited to this. The device that performs learning of the action recognizer and the device that performs action recognition may be configured as separate devices. In this case, if parameters of the action recognizer can be exchanged between the action recognition learning device that performs learning of the action recognizer and the action recognition device that performs action recognition, the parameters of the action recognizer may be stored in any one of the action recognition learning device, the action recognition device and other storage devices.

Note that the program, which is software (program) read and executed by the CPU in the above embodiments may be executed by various processors other than the CPU. As the processor in this case, a PLD (programmable logic device), a circuit configuration of which can be changed after manufacturing an FPGA (field-programmable gate array) and a dedicated electric circuit, which is a processor having a circuit configuration specially designed to execute a specific process such as an ASIC (application specific integrated circuit) can be illustrated as examples. The program may be executed by one of such various processors or a combination of two or more identical or different types of processors (e.g., a plurality of FPGAs or a combination of a CPU and an FPGA). A hardware-like structure of such various processors is more specifically an electric circuit that combines circuit elements such as semiconductor elements.

Although the aspects of the above embodiments in which a program is stored (installed) in the ROM 12 or the storage 14 in advance have been described, but the present invention is not limited to such aspects. The program may be provided in the form of being stored in a non-transitory storage medium such as a CD-ROM (compact disk read only memory), a DVD-ROM (digital versatile disk read only memory) and a USB (universal serial bus) memory. The program may be provided in the form of being downloaded from an external device via a network.

In addition, the following appendices regarding the above embodiments will be disclosed.

(Appendix 1)

An action recognition device comprising:

a memory; and

at least one processor connected to the memory, in which the processor is configured so as to:

receive input of a learning video and an action label indicating an action of an object,

detect a plurality of objects included in each frame image included in the learning video,

calculate a direction of a reference object, which is an object to be used as a reference among the plurality of objects detected by the detection unit,

normalize the learning video so that a positional relationship between the reference object and another object becomes a predetermined relationship, and

optimize parameters of the action recognizer based on the action estimated by inputting the learning video normalized by the normalization unit to an action recognizer to estimate an action of the object in the inputted video and an action indicated by the action label.

(Appendix 2)

A non-transitory storage medium that stores a program for causing a computer to:

receive input of a learning video and an action label indicating an action of an object,

detect a plurality of objects included in each frame image included in the learning video,

calculate a direction of a reference object, which is an object to be used as a reference among the plurality of objects detected by the detection unit,

normalize the learning video so that a positional relationship between the reference object and another object becomes a predetermined relationship, and

optimize parameters of the action recognizer based on the action estimated by inputting the learning video normalized by the normalization unit to an action recognizer to estimate an action of the object in the inputted video and an action indicated by the action label.

(Appendix 3)

A program for causing a computer to execute processes:

by an input unit to receive input of a learning video and an action label indicating an action of an object,

by a detection unit to detect a plurality of objects included in each frame image included in the learning video,

by a direction calculation unit to calculate a direction of a reference object, which is an object to be used as a reference among the plurality of objects detected by the detection unit,

by a normalization unit to normalize the learning video so that a positional relationship between the reference object and another object becomes a predetermined relationship, and

by an optimization unit to optimize parameters of the action recognizer based on the action estimated by inputting the learning video normalized by the normalization unit to an action recognizer to estimate an action of the object in the inputted video and an action indicated by the action label.

### REFERENCE SIGNS LIST

10 action recognition device

11 CPU

12 ROM

13 RAM

14 storage

15 input unit

16 display unit

17 communication interface

19 bus

101 input unit

102 detection unit

103 direction calculation unit

104 normalization unit

105 optimization unit

106 storage unit

107 action recognition unit

108 output unit

1. An action recognition learning device comprising a processor configured to execute a method comprising:
receiving input of a learning video and an action label indicating an action of an object,
detecting a plurality of objects included in each frame image included in the learning video,
calculating a direction of a reference object, which is an object to be used as a reference among the plurality of objects,
normalizing the learning video so that a positional relationship between the reference object and another object becomes a predetermined relationship, and
optimizing parameters of an action recognizer to estimate the action of the object in the inputted video.

2. The action recognition learning device according to claim 1, the processor further configured to execute a method comprising:
normalizing the learning video by performing at least one of rotation and flipping.

3. The action recognition learning device according to claim 1, wherein the calculating further includes estimating an object direction based on an angle of a normal of a contour of the reference object.

4. The action recognition learning device according to claim 1, the processor further configured to execute a method comprising:
normalizing by rotating the learning video so that the direction of the reference object becomes a predetermined direction and flipping the rotated learning video so that the positional relationship between the reference object and the other object becomes the predetermined relationship.

5. An action recognition device comprising a processor configured to execute a method comprising:
receiving input of an input video;
detecting a plurality of objects included in each frame image included in the input video;
calculating a direction of a reference object, which is an object to be used as a reference among the plurality of objects detected;
normalizing the input video so that a positional relationship between the reference object and another object becomes a predetermined relationship; and
estimating the action of the object in the inputted video using an action recognizer.

6. The action recognition learning device according to claim 1,
wherein the receiving further receives input of an optical flow indicating motion features corresponding to the respective frame images included in the learning video,
wherein the action recognizer is a model that receives a video and an optical flow corresponding to the video and estimates an action of an object in the inputted video,
wherein the normalizing further normalizes the learning video and an optical flow corresponding to the learning video so that the positional relationship between the reference object and the other object becomes the predetermined relationship, and
wherein the optimizing further optimizes the parameters of the action recognizer so that the estimated action matches the action indicated by the action label.

7. A method for learning an action recognition, the method comprising:
receiving input of a learning video and an action label indicating an action of an object;
detecting a plurality of objects included in each frame image included in the learning video;
calculating a direction of a reference object, which is an object to be used as a reference among the plurality of objects detected;
normalizing the learning video so that a positional relationship between the reference object and another object becomes a predetermined relationship; and
optimizing parameters of an action recognizer to estimate an action of the object in the inputted video based on the action estimated by inputting the learning video normalized by the normalization unit to the action recognizer and an action indicated by the action label.

8. (canceled)

9. The action recognition learning device according to claim 1, wherein the object includes either a person or a vehicle.

10. The action recognition learning device according to claim 2, wherein the calculating further includes estimating an object direction based on an angle of a normal of a contour of the reference object.

11. The action recognition learning device according to claim 2, the processor further configured to execute a method comprising:
normalizing by rotating the learning video so that the direction of the reference object becomes a predetermined direction and flipping the rotated learning video so that the positional relationship between the reference object and the other object becomes the predetermined relationship.

12. The action recognition learning device according to claim 3, the processor further configured to execute a method comprising:
normalizing by rotating the learning video so that the direction of the reference object becomes a predetermined direction and flipping the rotated learning video so that the positional relationship between the reference object and the other object becomes the predetermined relationship.

13. The action recognition device according to claim 5, wherein the object includes either a person or a vehicle.

14. The action recognition device according to claim 5, the processor further configured to execute a method comprising:
normalizing the learning video by performing at least one of rotation and flipping.

15. The action recognition device according to claim 5, wherein the calculating further includes estimating an object direction based on an angle of a normal of a contour of the reference object.

16. The action recognition device according to claim 5, the processor further configured to execute a method comprising:
normalizing by rotating the learning video so that the direction of the reference object becomes a predetermined direction and flipping the rotated learning video so that the positional relationship between the reference object and the other object becomes the predetermined relationship.

17. The method according to claim 7, wherein the object includes either a person or a vehicle.

18. The method according to claim 7, the method further comprising:
normalizing the learning video by performing at least one of rotation and flipping.

19. The method according to claim 7, wherein the calculating further includes estimating an object direction based on an angle of a normal of a contour of the reference object.

20. The method according to claim 7, the method further comprising:
normalizing by rotating the learning video so that the direction of the reference object becomes a predetermined direction and flipping the rotated learning video so that the positional relationship between the reference object and the other object becomes the predetermined relationship.

21. The method according to claim 18, the method further comprising:
normalizing by rotating the learning video so that the direction of the reference object becomes a predetermined direction and flipping the rotated learning video so that the positional relationship between the reference object and the other object becomes the predetermined relationship.
